(19) United States
(12) Patent Application Publication
(10) Pub. No.: US 2018/0015979 A1
(43) Pub. Date: Jan. 18, 2018

(54) Steering Device

(71) Applicant: Bayerische Motoren Werke Aktiengesellschaft, Muenchen (DE)

(72) Inventors: Elmar JAEGER, Kempten im Allgaeu (DE); Rudolf SCHRUPP, Germering (DE)

(21) Appl. No.: 15/718,203

(22) Filed: Sep. 28, 2017

Related U.S. Application Data
(63) Continuation of application No. PCT/EP2016/064279, filed on Jun. 21, 2016.

(30) Foreign Application Priority Data
Jul. 1, 2015 (DE) 10 2015 212 295.6

(51) Int. Cl. B62K 21/26; B62K 21/14

(52) U.S. Cl. CPC B62K 21/26; B62K 21/14

(57) ABSTRACT

A steering device, in particular for single-track vehicles, is provided. The steering device includes a support structure, an encapsulating casing which surrounds at least part of a surface of the support structure, and a vibration damper that is located within the encapsulating casing or between the encapsulating casing and the support structure.

### CROSS REFERENCE TO RELATED APPLICATIONS

This application is a continuation of PCT International Application No. PCT/EP2016/064279, filed Jun. 21, 2016, which claims priority under 35 U.S.C. §119 from German Patent Application No. 10 2015 212 295.6, filed Jul. 1, 2015, the entire disclosures of which are herein expressly incorporated by reference.

### BACKGROUND AND SUMMARY OF THE INVENTION

The present invention relates to a steering device, in particular for single track vehicles.

Single track vehicles are known from the prior art as motorcycles, motor scooters, pedal scooters, bicycles, etc. Moreover, trikes, quads and snowmobiles are also known. All of said vehicles are controlled by a driver via a steering device, for example handlebars. By way of manual actuation of the handlebars, the steering front wheel or the steering front wheels or skids can be adjusted in such a way that it is possible to drive around bends.

Contemporary handlebars for single track vehicles are generally manufactured from metallic materials, in particular from steel or aluminum. Metallic handlebars have the disadvantage, however, that they are sensitive to the transmission of vibrations. Said vibrations cause oscillations on the rear view mirrors which are fastened to the edge regions of the handlebars. This results in comfort losses, since a driver can recognize the images in the rear view mirror only with difficulty. Furthermore, equalizing reservoirs for brake and clutch fluid are generally likewise arranged on the handlebars. The vibrations produce foaming of said fluids, which can even result in safety losses in particularly unfavorable cases.

In order to reduce said oscillations, it is an established practice on the market to use additional weights which are fastened to the face-side ends of the handlebars. As an additional component, they represent an unnecessary increase in the overall vehicle weight. Furthermore, said vibration dampers are susceptible to faults, since their fastening bolts are loosened easily and therefore the vibration damper is frequently lost.

In addition, handlebars made from aluminum have the disadvantage of high thermal conductivity. Precisely in the case of grip heaters which have emerged on a widespread scale recently, there is the disadvantage that the heat which is intended for the grips is reduced greatly by heat losses which migrate into the handlebars.

Proceeding from said prior art, it is the object of the present invention to specify a steering device which is distinguished by a low weight and a low sensitivity to oscillations.

In order to achieve this object, the invention proposes a steering device, in particular for single track vehicles, having a supporting structure, an encapsulation which surrounds a surface of the supporting structure at least in sections, and a vibration damper. Single track vehicles within the context of the invention are motorcycles, motor scooters, bicycles, pedal scooters and the like. It goes without saying that the invention can also be used in double track or multiple track vehicles such as trikes, quads, snowmobiles and the like. The supporting structure may be configured as a tube with a circular, oval or else polygonal cross-sectional profile. Said profile can be of straight, curved or elbowed configuration in its axial direction. Moreover, the vibration damper can be provided on a side of the encapsulation facing the supporting structure. An arrangement of this type affords the advantage of a very compact overall design.

In accordance with a first embodiment, the vibration damper is configured so as to be integrated in the encapsulation. In other words, the vibration damper is a constituent part of the encapsulation and is therefore configured in one piece. This results, inter alia, in manufacturing advantages during the production of the handlebars, since fewer individual parts have to be joined together.

Furthermore, the vibration damper may be configured as a coat or layer in the encapsulation. In addition to the compact overall design which saves a great amount of installation space, said construction affords advantages in terms of manufacturing technology, since the vibration damper is integrated during the production of the encapsulation.

In accordance with a second alternative embodiment of the invention, the vibration damper is arranged between the supporting structure and the encapsulation. In accordance with said embodiment, the vibration damper can be configured as a separate intermediate layer or as an intermediate coat. The construction in accordance with the second embodiment affords advantages with regard to great variability. The selection of the vibration dampers and therefore the damping properties can thus be carried out in a manner which is dependent on which frequencies or oscillations are to be damped.

In embodiments of the present invention, the supporting structure may be configured from metal, in particular from a light metal, such as aluminum, magnesium, titanium, etc.

The encapsulation may be configured from fiber reinforced plastic. The reinforcing fibers may be organic or inorganic reinforcing fibers. The reinforcing fibers may be, for example, carbon fibers. The latter form a carbon fiber reinforced plastic with the plastic matrix, also called CFRP (carbon fiber reinforced plastic). The associated FRP component is then a CFRP component. The reinforcing fibers can, for example, also be configured from glass fibers. The latter form a glass fiber reinforced plastic with the plastic matrix, also called GFRP. The associated fiber reinforced plastic component is then a GFRP component. The invention is not to be restricted to this, however, and the reinforcing fibers may also be, for example, aramid fibers, polyester fibers, nylon fibers, polyethylene fibers, PMMA fibers, basalt fibers, boron fibers, ceramic fibers, silicic acid fibers, steel fibers and/or natural fibers. From an economic point of view, all the cited fibers may also be recycling fibers.

The material of the plastic matrix may comprise, in particular, one or more thermoplastics and/or thermosets. Fiber reinforced plastics with a thermoplastic matrix have the advantage that they can subsequently be reshaped or welded. For example, polyether ether ketone (PEEK), polyphenolene sulfide (PPS), polysulfone (PSU), polyetherimide (PEI) and/or polytetrafluoroethylene (PTFE) are suitable as thermoplastics. Fiber reinforced plastics with a thermoset matrix can no longer be reshaped after curing or crosslinking of the matrix. They advantageously have a high temperature use range. This applies, in particular, to heat cured systems which are cured at high temperatures. Fiber reinforced plastics with a thermoset matrix usually have the highest strengths. The following resins may be used as thermosetting plastics or matrix, for example: epoxy resin (EP), unsaturated polyester resins (UP), vinyl ester resins (VE), phenol formaldehyde resin (PF), methacrylate resins (MA), polyurethane (PUR), amino resins, melamine resins (MF/MP) and/or urea resin (UF). The use of fiber reinforced plastic affords the advantage that the supporting structure can be of thin-walled configuration, which results in weight advantages with identical mechanical properties of the overall steering device. Moreover, the use of carbon fiber reinforced plastic has the advantage that a thermal insulation is produced. This results in a higher degree of efficiency of the grip heater.

In embodiments of the present invention, the vibration damper may be configured from a plastic, in particular an elastomer. Particularly satisfactory vibration damping can be produced by way of the use of an elastomer. Moreover, the elastomer assumes an anti-corrosion property between the encapsulation and the supporting structure. Last but not least, it compensates for the different thermal expansions between the encapsulation and the supporting structure.

The encapsulation may enclose the supporting structure completely or in sections. An encapsulation can preferably be provided in edge sections of the steering device, a center section remaining free from encapsulation. This affords the advantage that a thermal insulation by way of the encapsulation is produced only in the edge regions, in which the handles of the handlebars are provided. At the same time, no encapsulation is provided in the center section, in which clamping fastening to the front wheel steering control usually takes place. As a result, higher clamping forces can be realized than in embodiments, in which the encapsulation is of continuous configuration. In particular, encapsulations made from carbon fiber are liable to fracture in the case of high clamping forces.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a side view of a supporting structure of a steering device.

FIG. 2 shows a sectional view through a handle region of a steering device in accordance with a first embodiment of the present invention.

FIG. 3 shows a sectional view through a handle region of a steering device in accordance with a second embodiment of the present invention.

### DETAILED DESCRIPTION OF THE DRAWINGS

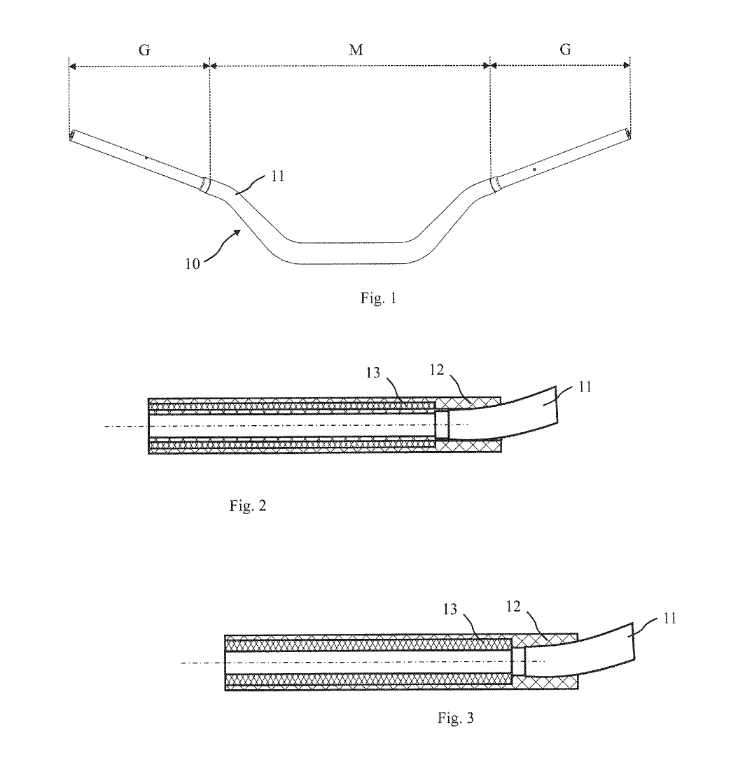

FIG. 1 shows a side view of a steering device, in which side view only the supporting structure 11 is depicted. The supporting structure 11 is shown as handlebars which are configured in the axial direction from straight, curved and elbowed sections. The lateral or side regions are elbowed. Handle regions G are provided in the axial end regions, in which handle regions G handles can be mounted. The middle region M serves for fastening the handlebars 10 to a front wheel control device, for example a front wheel fork.

FIG. 2 shows a sectional view through the handle region G of a steering device 10 in accordance with a first embodiment. In this region, the supporting structure 11 is surrounded by an encapsulation 12. In other words, the supporting structure 11 has a substantially cylindrical, prismatic shape, the axial course of which, however, can have not only straight sections, but rather also curved sections. The encapsulation 12 is applied in sections on the circumferential face of said prism. The encapsulation 12 is preferably formed from a carbon fiber reinforced plastic. A vibration damper 13 is incorporated into the encapsulation 12 integrally, that is to say in one piece. Said vibration damper 13 is configured on one side of the encapsulation 12, that is to say on an inner side of the encapsulation 12, with the result that it bears as closely as possible to an outer circumferential face of the supporting structure 11. Here, the vibration damper 13 is manufactured from elastomer.

The encapsulation 12 is a carbon fiber reinforced plastic which is configured from a plurality of individual coats. As a consequence, one of said coats or layers is configured as a vibration damper made from elastomer 13. As can be seen from FIG. 2, the vibration damper 13 does not extend completely through the encapsulation 12 in the axial direction, but rather penetrates it only in sections. It goes without saying that, in a further embodiment 13 (not shown), the vibration damper 13 can extend completely in the axial direction, that is to say precisely as far as the encapsulation 12.

A second, alternative embodiment of the invention is shown in FIG. 3. As has already been described in reference to FIG. 2, the steering device 10 comprises a supporting structure 11 which is surrounded by an encapsulation 12. A vibration damper 13 is provided between the encapsulation 12 and the supporting structure 11. In accordance with the embodiment which is shown in FIG. 3, the vibration damper 13 is a separate component and is introduced as an intermediate layer between the supporting structure 11 and the encapsulation 12. The vibration damper 13 is also shown here to be shorter in its longitudinal direction than the encapsulation 12. In a further embodiment (not shown), the vibration damper 13 can likewise be configured over the complete length of the encapsulation 12.

As shown in FIG. 1, the encapsulations and the vibration dampers are arranged merely in the handle region G. In a further embodiment of the invention, however, the supporting structure 10 can be surrounded completely, that is to say completely in the axial direction by an encapsulation and/or else completely by a vibration damper.

The present invention therefore also affords the advantage that particularly light handlebars are realized. Since the handlebars generally belong to the components of the motorcycle which lie at the highest point, the center of gravity of the motorcycle can be lowered effectively by way of a reduction of the handlebar weight.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A steering device for single track vehicles, comprising:
a supporting structure;
an encapsulation surrounding at least a section of a surface of the supporting structure; and
a vibration damper surrounding at least a portion of the section of the surface of the supporting structure and located radially inward of an outer side of the encapsulation facing away from the supporting structure.

2. The steering device as claimed in claim 1, wherein
the vibration damper is integrated in the encapsulation.

3. The steering device as claimed in claim 2, wherein
the vibration damper is configured as a layer in the encapsulation.

4. The steering device as claimed in claim 1, wherein
the vibration damper is located between the supporting structure and the encapsulation.

5. The steering device as claimed in claim 4, wherein
the vibration damper is a separate intermediate layer between the supporting structure and the encapsulation.

6. The steering device as claimed in claim 1, wherein
a material of the supporting structure is metal.

7. The steering device as claimed in claim 6, wherein
the metal is a light metal.

8. The steering device as claimed in claim 7, wherein
a material of the encapsulation is fiber reinforced plastic.

9. The steering device as claimed in claim 8, wherein
a material of the vibration damper is a plastic, in particular from elastomer.

10. The steering device as claimed in claim 9, wherein
the plastic is an elastomer.

11. The steering device as claimed in claim 1, wherein
the encapsulation surrounds lateral end sections of the supporting structure, and does not surround a center section of the supporting structure.
